(19) United States
(12) Patent Application Publication
(10) Pub. No.: US 2001/0017625 A1
(43) Pub. Date: Aug. 30, 2001

(54) Character processing apparatus, character processing system, character processing method and storage medium

(76) Inventor: Kaoru Shimamura, Kawasaki (JP)

Correspondence Address: STAAS & HALSEY LLP, 700 11TH STREET, NW, SUITE 500, WASHINGTON, DC, 20001, US

(21) Appl. No.: 09/785,219

(22) Filed: Feb. 20, 2001

(30) Foreign Application Priority Data
Feb. 25, 2000 (JP) 2000-050051

(51) Int. Cl. G06T 11/00

(52) U.S. Cl. 345/467

(57) ABSTRACT

A character processing apparatus includes a receiving section receiving a request for character information, a code allocating section allocating a code to the requested character information, a control section controlling creation of the requested character information, and a setting section setting created character information with respect to the allocated code.

### BACKGROUND OF THE INVENTION

This application claims the benefit of a Japanese Patent Application No. 2000-050051 filed Feb. 25, 2000, in the Japanese Patent Office, the disclosure of which is hereby incorporated by reference.

1. Field of the Invention

The present invention generally relates to character processing apparatuses, character processing systems, character processing methods and storage media, and more particularly to a character processing apparatus, a character processing system and a character processing method capable of using a number of graphic character codes exceeding a number of characters that may be registered as external characters, and to a computer-readable storage medium which stores a program for causing a computer to process such graphic character codes.

Generally, in systems which process graphic character codes, the graphic character codes are categorized into the graphic character codes of internal characters and the graphic character codes of external characters. The internal characters are defined by the system, while the external characters can be defined arbitrarily by the user. The present invention relates to the registration of the graphic character codes of the external characters.

2. Description of the Related Art

In a document editing system which uses a large number of characters, missing characters are registered as external characters. The external characters are registered by extracting in advance the external characters which are expected to be used, creating an external character file depending on a number of characters that can be registered in the system, and registering the created external character file in the system.

Conventionally, the operation of extracting the external characters is carried out manually by the operator, by relying on the operator's eyes to visually refer to a printed code table, for example. The external characters which are registered in a master font file are listed in the printed code table.

Accordingly, when conventionally carrying out a developing process which requires the use of external characters, it is necessary to carry out a process to extract the external characters in advance. As a result, there was a problem in that it takes a long time to carry out the entire developing process, such as creating a publication.

In addition, since the conventional operation of extracting the external characters is carried out manually by visually referring to the printed code table or the like, there was also a problem in that it takes time to complete the operation of extracting the external characters.

### SUMMARY OF THE INVENTION

Accordingly, it is a general object of the present invention to provide a novel and useful character processing apparatus, character processing system, character processing method and computer-readable storage medium, in which the problems described above are eliminated.

Another and more specific object of the present invention is to provide a character processing apparatus, a character processing system, a character processing method and a computer-readable storage medium, which can reduce the time required to carry out a process which requires the use of external characters, and/or easily register the external characters.

Still another object of the present invention is to provide a character processing apparatus comprising a receiving section receiving a request for character information, a code allocating section allocating a code to the requested character information, a control section controlling creation of the requested character information, and a setting section setting created character information with respect to the allocated code. According to the character processing apparatus of the present invention, it is possible to create the character information such as an external character and allocate the code to the external character, by requesting the external character. In addition, it is unnecessary to extract the external character in advance, and the developing process can be reduced, since an editing operation does not require interruption even when the external character needs to be registered.

A further object of the present invention is to provide a character processing system comprising at least one input terminal equipment, and a character processing apparatus coupled to the at least one input terminal equipment, where the input terminal equipment comprises a requesting section requesting character information with respect to the character processing apparatus, and the character processing apparatus comprises an allocating section allocating a code to the character information requested by the requesting section, a first notifying section notifying the code to the input terminal equipment, a creating section creating the requested character information, and a second notifying section notifying the created character information to the input terminal equipment. According to the character processing system of the present invention, the code of the required character information is notified in advance to the input terminal equipment, and the character information is set with respect to the code after the character information is created, thereby enabling the input terminal equipment to set the required code at a desired position and continue an input operation.

Another object of the present invention is to provide a character processing method comprising the steps of (a) receiving a request for character information, (b) allocating a code to the requested character information, (c) controlling creation of the requested character information, and (d) setting created character information with respect to the allocated code. According to the character processing method of the present invention, it is possible to create the character information such as an external character and allocate the code to the external character, by requesting the external character. In addition, it is unnecessary to extract the external character in advance, and the developing process can be reduced, since an editing operation does not require interruption even when the external character needs to be registered.

Still another object of the present invention is to provide a character processing method comprising the steps of (a) requesting character information from an input terminal equipment with respect to a character processing apparatus, (b) allocating a code to the character information requested by the step (a), (c) notifying the code to the input terminal equipment, (d) creating the requested character information, and (e) notifying the created character information to the input terminal equipment. According to the character processing method of the present invention, the code of the required character information is notified in advance to the input terminal equipment, and the character information is set with respect to the code after the character information is created, thereby enabling the input terminal equipment to set the required code at a desired position and continue an input operation.

A further object of the present invention is to provide a character processing method comprising the steps of (a) requesting character information from an input terminal equipment with respect to a character processing apparatus, (b) allocating a code to the character information requested by the step (a), (c) creating the requested character information, and (d) notifying the created character information to the input terminal equipment. According to the character processing method of the present invention, it is possible to directly display the character information at the input terminal equipment by notifying the character information to the input terminal equipment.

Another object of the present invention is to provide a computer-readable storage medium which stores a program for causing a computer to carry out the steps of (a) receiving a request for character information, (b) allocating a code to the requested character information, (c) controlling creation of the requested character information, and (d) setting created character information with respect to the allocated code. According to the computer-readable storage medium of the present invention, it is possible to create the character information such as an external character and allocate the code to the external character, by requesting the external character. In addition, it is unnecessary to extract the external character in advance, and the developing process can be reduced, since an editing operation does not require interruption even when the external character needs to be registered.

Still another object of the present invention is to provide a computer-readable storage medium which stores a program for causing a computer to carry out the steps of (a) requesting character information from an input terminal equipment with respect to a character processing apparatus, (b) allocating a code to the character information requested by the step (a), (c) notifying the code to the input terminal equipment, (d) creating the requested character information, and (e) notifying the created character information to the input terminal equipment. According to the computer-readable storage medium of the present invention, the code of the required character information is notified in advance to the input terminal equipment, and the character information is set with respect to the code after the character information is created, thereby enabling the input terminal equipment to set the required code at a desired position and continue an input operation.

A further object of the present invention is to provide a computer-readable storage medium which stores a program for causing a computer to carry out the steps of (a) requesting character information from an input terminal equipment with respect to a character processing apparatus, (b) allocating a code to the character information requested by the step (a), (c) creating the requested character information, and (d) notifying the created character information to the input terminal equipment. According to the computer-readable storage medium of the present invention, it is possible to directly display the character information at the input terminal equipment by notifying the character information to the input terminal equipment.

Other objects and further features of the present invention will be apparent from the following detailed description when read in conjunction with the accompanying drawings.

### BRIEF DESCRIPTION OF THE DRAWINGS

FIG. 1 is a system block diagram showing a first embodiment of the present invention;

FIG. 2 is a system block diagram showing an external character creating terminal equipment of the first embodiment of the present invention;

FIG. 3 is a system block diagram showing an external character managing terminal equipment of the first embodiment of the present invention;

FIG. 4 is a system block diagram showing an input terminal equipment of the first embodiment of the present invention;

FIG. 5 is a diagram showing a data structure of a master font data of the first embodiment of the present invention;

FIG. 6 is a diagram showing a data structure of internal and external character fonts of the first embodiment of the present invention;

FIG. 7 is a diagram showing a data structure of a font code table of the first embodiment of the present invention;

FIG. 8 is a diagram showing a data structure of an external character font creating definition file of the first embodiment of the present invention;

FIG. 9 is a diagram showing a data structure of an external character code table of the first embodiment of the present invention;

FIG. 10 is a diagram showing a data structure of a font code table after external character correspondence of the first embodiment of the present invention;

FIG. 11 is a diagram for explaining the operation of the first embodiment of the present invention;

FIG. 12 is a diagram showing an input screen of the first embodiment of the present invention;

FIG. 13 is a diagram for explaining the operation of a second embodiment of the present invention;

FIG. 14 is a system block diagram showing an external character managing terminal equipment of a third embodiment of the present invention;

FIG. 15 is a diagram showing a data structure of an external character environment managing table of the third embodiment of the present invention;

FIG. 16 is a diagram for explaining the operation of the third embodiment of the present invention; and

FIG. 17 is a diagram showing an external character environment selection screen of the third embodiment of the present invention.

### DESCRIPTION OF THE PREFERRED EMBODIMENTS

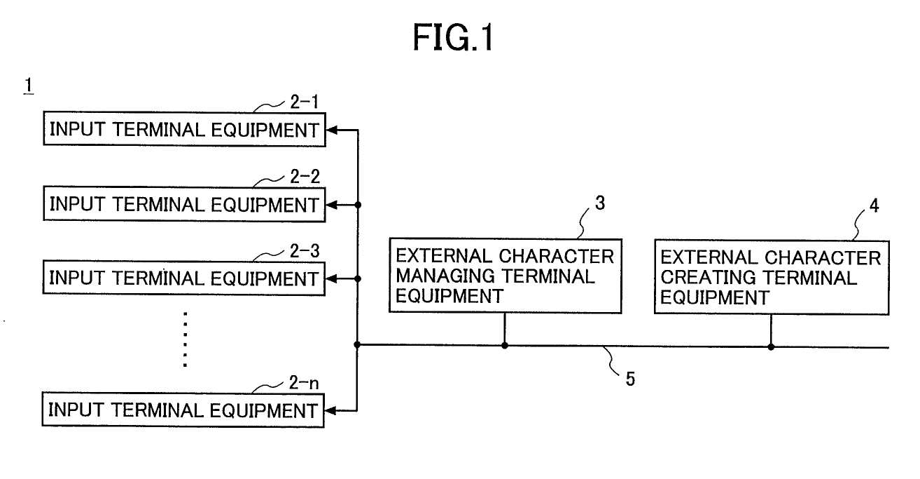

FIG. 1 is a system block diagram showing a first embodiment of the present invention. A document processing system 1 of this embodiment includes input terminal equipments 2-1 through 2-n, an external character managing terminal equipment 3, an external character creating terminal equipment 4, and a network 5 which are connected as shown in FIG. 1. Characters are input from the input terminal equipments 2-1 through 2-n, and the external character managing terminal equipment 3 manages external characters which are used in the input terminal equipments 2-1 through 2-n. The external character creating terminal equipment 4 creates external characters based on requests from the external character managing terminal equipment 3.

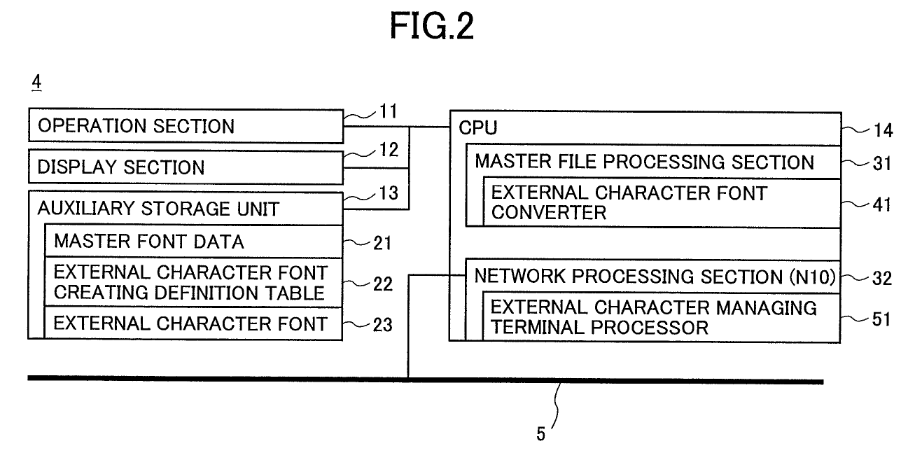

FIG. 2 is a system block diagram showing the external character creating terminal equipment 4 of this embodiment. As shown in FIG. 2, the external character creating terminal equipment 4 includes an operation section 11, a display section 12, an auxiliary storage unit 13, and a CPU 14.

The operation section 11 is formed by a keyboard, mouse or the like, and is used to carry out operations such as making various sections and settings and inputting characters. The display section 12 displays characters, images, states of the system and the like.

The auxiliary storage unit 13 stores data including master font data 21, external character font creating definition table 22 and external character font 23. The master font data 21 are formed by character pattern data such as dots and outlines, in logic codes. The external character font creating definition table 22 defines font codes (external character codes) in logic codes. The external character font 23 is formed by character pattern data such as dots and outlines, in font codes (external character codes). The auxiliary storage unit 13 may be formed by any kind of memory or storage unit capable of storing information, such as semiconductor memories, and magnetic, optical and magneto-optical recording media such as disks.

The CPU 14 realizes various kinds of processing functions, and includes a master file processing section 31 and a network processing section 32. The master file processing section 21 includes an external character font converter 41. The external character font converter 41 has a function of creating the external character font 23 based on the master font data 21 and the external character font creating definition table 22. The network processing section 32 includes an external character managing terminal processor 51. The external character managing terminal processor 51 moves a file, exchanges notifying items, and makes a processing request, with respect to the external character managing terminal equipment 3, via the network 5.

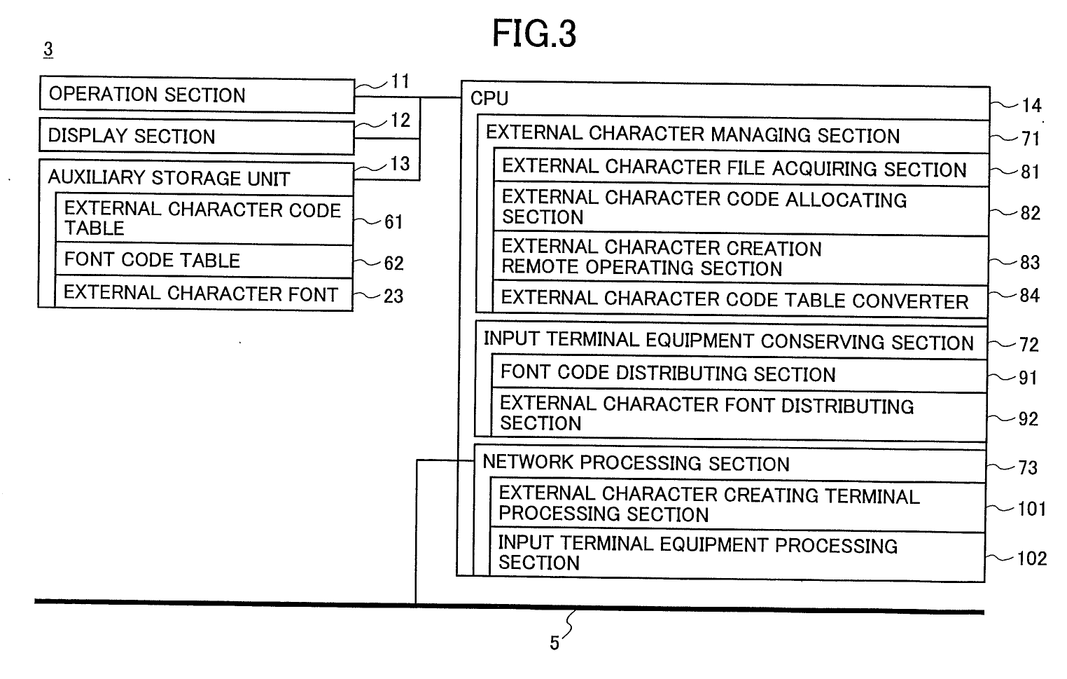

FIG. 3 is a system block diagram showing the external character managing terminal equipment 3 of this embodiment. In FIG. 3, those parts which are the same as those corresponding parts in FIG. 2 are designated by the same reference numerals, and a description thereof will be omitted.

The auxiliary storage unit 13 of the external character managing terminal equipment 3 stores the external character font 23, an external character code table 61, and a font code table 62. The external character code table 61 defines logic codes by font codes (external character codes). The font code table 62 defines the font codes by logic codes.

The CPU 14 of the external character managing terminal equipment 3 includes an external character managing section 71, an input terminal equipment conserving section 72, and a network processing section 73. The external character managing section 71 includes an external character file acquiring section 81, an external character code allocating section 82, an external character creation remote operating section 83, and an external character code table converter 84.

The external character file acquiring section 81 acquires an external character font from the external character creating terminal equipment 4. The external character code allocating section 82 allocates an external character code to a logic code corresponding to an external character code requested from an input terminal equipment 2-i, where i=1, . . . , n, and n is a positive integer. The external character creation remote operating section 83 remotely operates an external character font converting function of the external character creating terminal equipment 4. The external character code table converter 84 converts the external character code table 61 into the external character font creating definition table 22.

The input terminal equipment conserving section 72 includes a font code distributing section 91, and an external character font distributing section 92. The font code distributing section 91 updates the font code table 62 of the input terminal equipment 2-i. The external character font distributing section 92 updates the external character font 23 of the input terminal equipment 2-i.

The network processing section 73 includes an external character creating terminal processing section 101, and an input terminal equipment processing section 102. The external character creating terminal processing section 101 moves a file, exchanges notifying items, and makes a processing request, with respect to the external character creating terminal equipment 4, via the network 5. The input terminal equipment processing section 102 moves an input file, exchanges notifying items, and makes a processing request, with respect to the input terminal equipment 2-i, via the network 5.

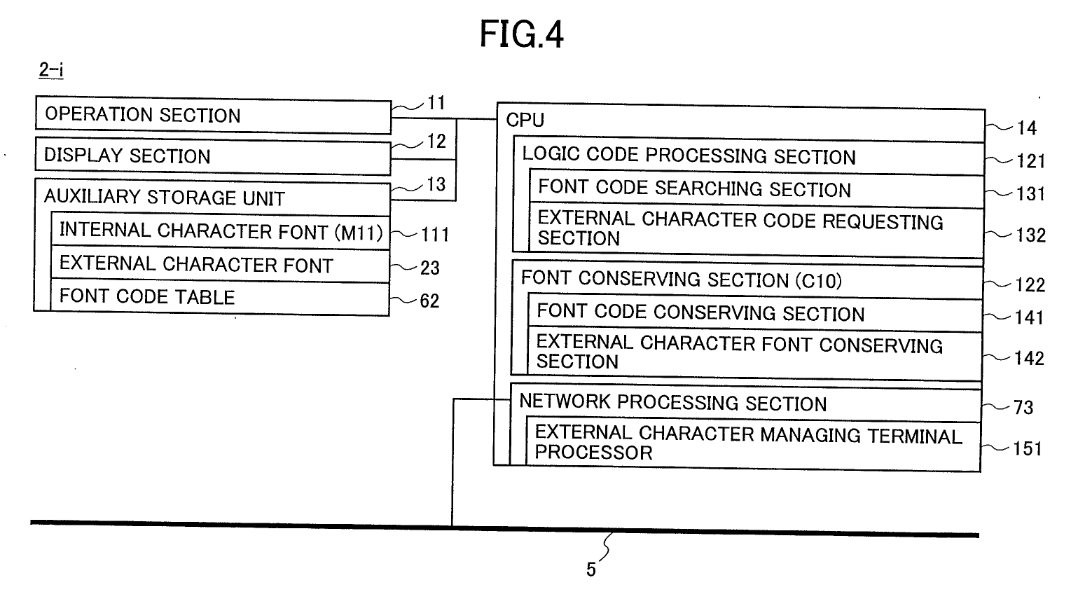

FIG. 4 is a system block diagram showing the input terminal equipment 2-i of this embodiment. In FIG. 4, those parts which are the same as those corresponding parts in FIGS. 2 and 3 are designated by the same reference numerals, and a description thereof will be omitted.

The auxiliary storage unit 13 of the input terminal equipment 2-i includes the external character font 23, the font code table 62, and an internal character font 111. The internal character font 111 is formed by character pattern data such as dots and outlines, in font codes (internal character codes).

The CPU 14 of the input terminal equipment 2-i includes a logic code processing section 121, a font conserving section 122, and the network processing section 73. The logic code processing section 121 includes a font code searching section 131, and an external character code requesting section 132. The font code searching section 131 searches for a font code corresponding to a logic code. The external character code requesting section 132 allocates an external character code to a logic code with no defined font code, with respect to the external character managing terminal equipment 3.

The font managing section 122 includes a font code conserving section 141, and an external character font conserving section 142. The font code conserving section 141 updates the font code table 62 in response to an update notification from the external character managing terminal equipment 3. The external character font conserving section 142 updates an external character font in response to an update notification from the external character managing terminal equipment 3.

The network processing section 73 includes an external character managing terminal processor 151. The external character managing terminal processor 151 moves a file, exchanges notifying items, and makes a processing request, with respect to the external character managing terminal equipment 3, via the network 5.

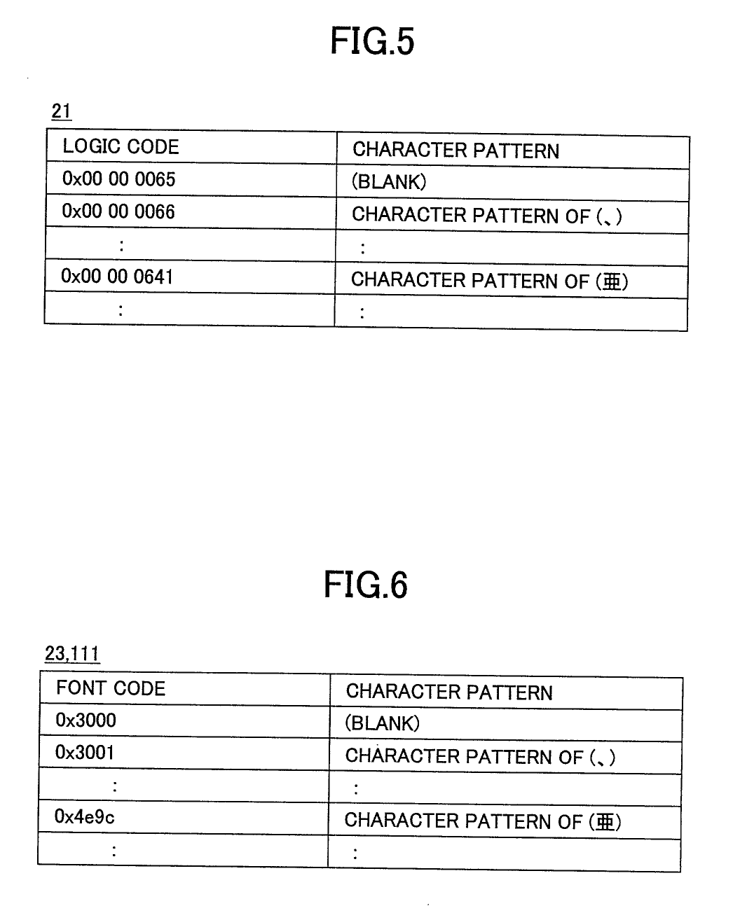

Next, a description will be given of the master font data 21 stored in the auxiliary storage unit 13 of the external character creating terminal equipment 4, by referring to FIG. 5. FIG. 5 is a diagram showing a data structure of the master font data 21 of this embodiment. As shown in FIG. 5, the master font data 21 includes a corresponding character pattern which is defined with respect to a logic code.

A description will be given of the external character font 23 and the internal character font 111, by referring to FIG. 6. FIG. 6 is a diagram showing a data structure of the external character font 23 and the internal character font 111 of this embodiment. As shown in FIG. 6, the external character font 23 and the internal character font 111 includes a corresponding character pattern which is defined with respect to a font code.

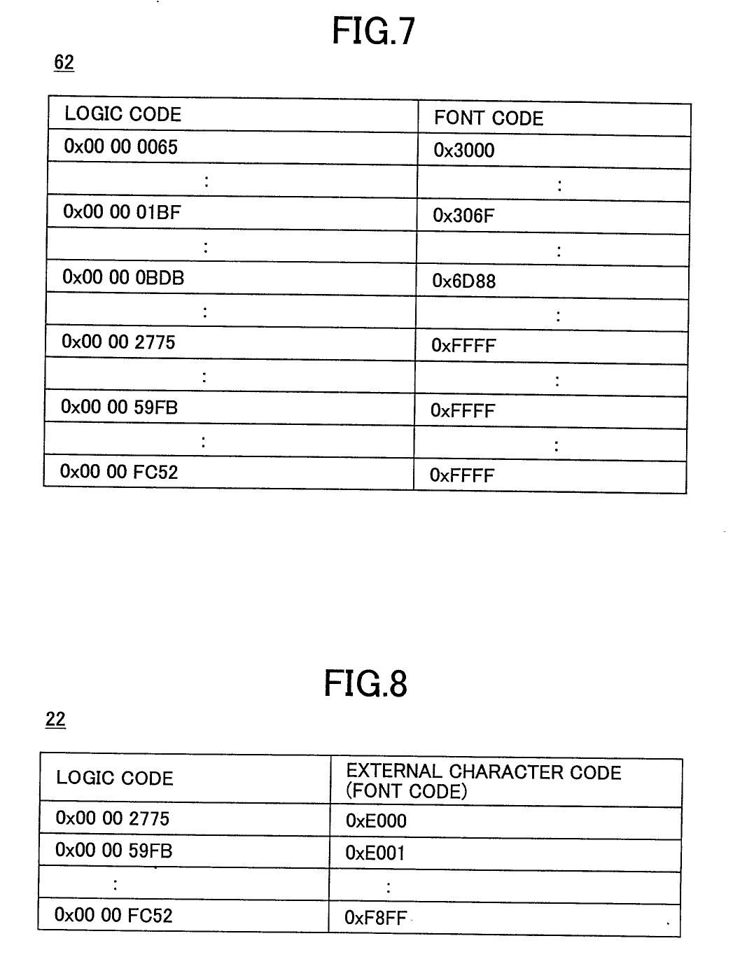

Next, a description will be given of the font code table 62, by referring to FIG. 7. FIG. 7 is a diagram showing a data structure of the font code table 62 of this embodiment. As shown in FIG. 7, the font code table 62 includes a corresponding font code which is defined with respect to a logic code.

A description will be given of the external character font creating definition table 22, by referring to FIG. 8. FIG. 8 is a diagram showing a data structure of the external character font creating definition table 22 of this embodiment. As shown in FIG. 8, the external character font creating definition table 22 includes a corresponding external character code which is defined with respect to a logic code.

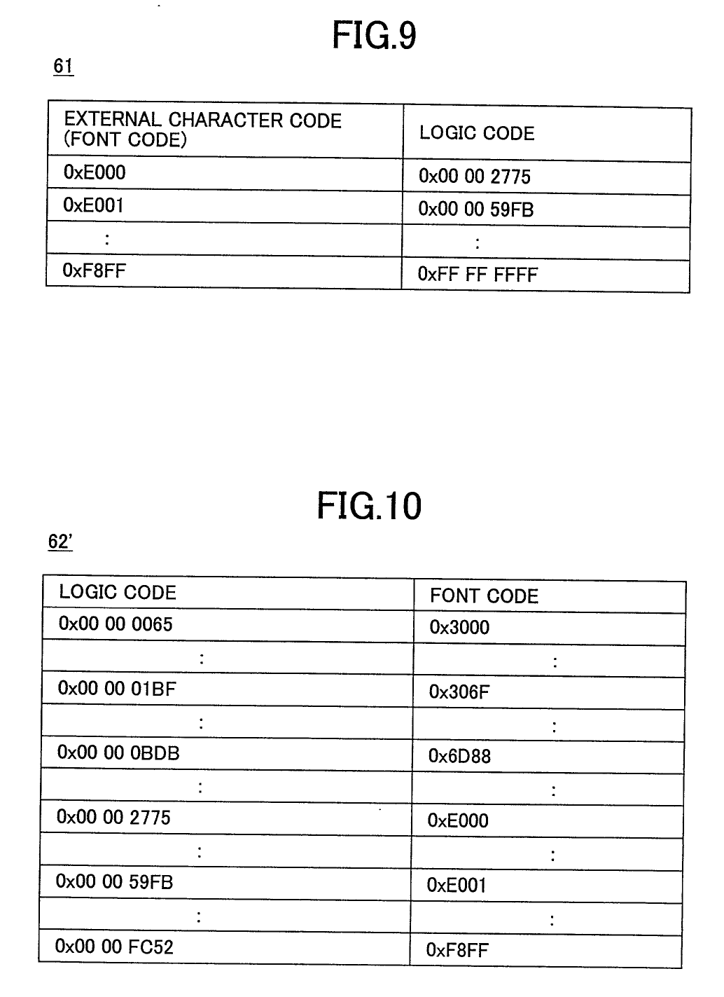

Next, a description will be given of the external character code table 61, by referring to FIG. 9. FIG. 9 is a diagram showing a data structure of the external character code table 61 of this embodiment. As shown in FIG. 9, the external character code table 61 includes a corresponding logic code which is defined with respect to an external character code.

A description will be given of a font code table 62′ after external character correspondence, by referring to FIG. 10. FIG. 10 is a diagram showing a data structure of the font code table 62′ after the external character correspondence of this embodiment. FIG. 10 shows the font code table 62′ after the external character correspondence, in a state where a font code “0×E000” is made to correspond to a logic code “0×0000 2775” having a corresponding font code “0×FFF” defined in the font code table 62 shown in FIG. 7.

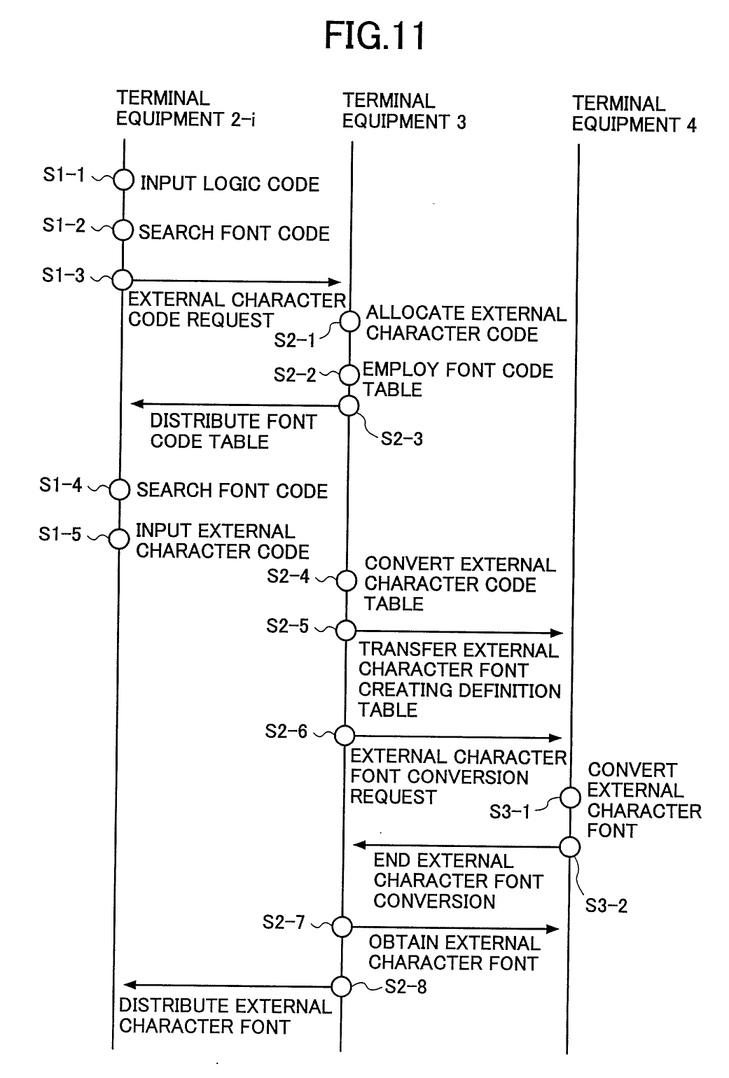

FIG. 11 is a diagram for explaining the operation of this embodiment. In FIG. 11, steps S11 through S1-5 are carried out by the input terminal equipment 2-i, steps S2-1 through S2-8 are carried out by the external character managing terminal equipment 3, and steps S3-1 and S3-2 are carried out by the external character creating terminal equipment 4.

In the step S1-1, a logic code is input from the operation section 11 of the input terminal equipment 2-i. This input of the logic code is made from a predetermined input screen which is displayed on the display section 12 by the operation of the operation section 12. For example, the operation of inputting the logic code is made when it is necessary to input a character which is not defined by the internal character code or the like when carrying out a document editing operation.

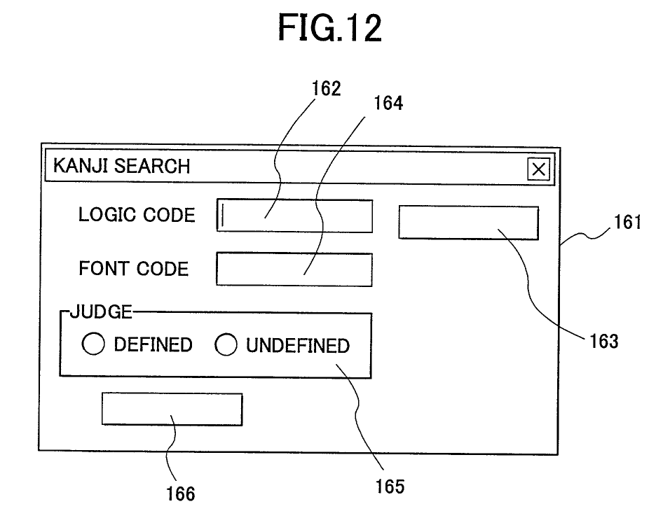

FIG. 12 is a diagram showing the input screen of this embodiment. An input screen 161 shown in FIG. 12 which is displayed on the display section 12 includes a logic code input part 162, a judging button 163, a font code display part 164, a code judgement display part 165, and an external character code request button 166.

A logic code for setting a Japanese Kanji character which is to be searched or a Japanese Kanji character which is to be registered as an external character, is input to the logic code input part 162. The judging button 163 is used to start an operation of judging whether a font code is defined or undefined with respect to the input logic code. The font code display part 164 displays a font code. The code judgement display part 165 displays a judgement result indicating that the font code is defined or undefined. The external character code request button 166 is used to start an external character code request when the judgement result indicates that the font code is undefined.

When the logic code is input in the step S1-i and the judging button 163 is selected, the step S1-2 searches for a font code corresponding to the input logic code. The font code searching section 131 carries out this step S1-2 by referring to the font code table 62 shown in FIG. 7 in order to search the font code from the logic code. When the font code is found as a result of the search, the font code searching section 131 displays the font code in the font code display part 164 of the input screen 161 shown in FIG. 12.

For example, when a font code other than “0×FFF” is found as a result of the search, the judgement result displayed in the code judgement display part 165 of the input screen 161 shown in FIG. 12 indicates that the font code is defined. In this case, the font code corresponding to the input logic code is displayed in the font code display part 164.

However, when an undefined font code such as “0×FFF” is found as a result of the search, the judgement result displayed in the code judgement display part 165 of the input screen 161 shown in FIG. 12 indicates that the font code is undefined. In this case, the font code corresponding to the input logic code cannot be input because the character of the input code is not registered in the system. For example, when the logic code “0×00 00 2775” is searched in the font code table 62 shown in FIG. 7, a font code “0FFF” is found, and it is judged that the font code is undefined.

When the external character code request button 166 is selected in the input screen 161 shown in FIG. 12, the step S1-3 makes an external character code request with respect to the external character managing terminal equipment 3 to allocate the external character code, by sending the logic code with the undefined font code to the external character managing terminal equipment 3. This step S1-3 is carried out by the external character code requesting section 132.

The external character code allocating section 82 of the external character managing terminal equipment 3 carries out the step S2-1 when the external character code request is made from the input terminal equipment 2-i in the step S1-3. The step S2-1 refers to the external character code table 61 shown in FIG. 9 and allocates an external character code (font code) to the logic code which is received from the input terminal equipment 2-i. More particularly, the logic codes of the external character code table 61 are successively referred to so as to find an external character code not allocated with a logic code such as “0×FF FF FFFF”. For example, when a logic code “0×00 00 2775W is received from the input terminal equipment 2-i and the logic code “0×FF FF FFFF” is allocated with respect to an external character code “0×E000” in the external character code table 61, the logic code “0×00 00 2775W is allocated to the external character code 0×E000 ” in the external character code table 61.

The external character code allocating section 82 carries out the step S2-2 to employ the font codes of the font code table 62 with respect to the logic codes allocated to the external character codes in the step S2-1. For example, when allocating the logic code “0×00 00 2775” to the external character code “0×E000” of the external character code table 61, the font code (external character code) “0×E000” is employed with respect to the logic code “0×00 00 2775” of the font code table 62.

The font code distributing section 91 carries out the step S2-3 to distribute the font code table 62 which is updated responsive to the external character code request to each input terminal equipment 2-i. In addition, the font code distributing section 91 notifies the font code conserving section 141 of each connected input terminal equipment 2-i that the font code table 62 is updated.

The font code conserving section 141 which receives the above notification from the font code distributing section 91 obtains the updated font code table 62 which is transferred from the font code distributing section 91, and replaces the font code table 62 by the updated font code table 62.

The input terminal equipment 2-i carries out the step S1-4 in response to an operation which is carried out from the operation section 11 shown in FIG. 4 with respect to the input screen 161 shown in FIG. 12, so as to search a font code. More particularly, when the judging button 163 of the input screen 161 is selected, the input terminal equipment 2-i refers to the font code table 62 shown in FIG. 7 to search the font code from the logic code. This time, the external character code (font code) “0×E000” is allocated with respect to the logic code “0×00 00 2775” which was previously undefined, and thus, the font code “0×E000” is found as a result of the search, and the judgement result displayed in the code judgement display part 165 of the input screen 161 shown in FIG. 12 indicates that the font code is defined.

It is possible to start searching the font code again in response to the completion of the external character code request in the step S2-3.

Next, the input terminal equipment 2-i carries out the step S1-5 to input an external character code with respect to a document which is being edited or the like.

The external character code table converter 84 of the external character managing terminal equipment 3 shown in FIG. 3 carries out the step S2-4 to convert the external character code table 61 which is used to manage the external character codes in the external character managing terminal equipment 3 into a file format suited for creating an external character font which is created in the external character creating terminal equipment 4. The external character code table 61 in the external character managing terminal equipment 3 has a format shown in FIG. 9. On the other hand, the external character font creating definition table 22 in the external character creating terminal equipment 4 used for creating the external character font and managing the external character codes has a format shown in FIG. 8.

The external character managing terminal equipment 3 carries out the step S2-4 to convert the external character code table 61 which is ordered according to the external character code into the external character font creating definition table 22 which is ordered according to the logic code.

The external character managing terminal equipment 3 carries out the step S2-5 to transfer the external character font creating definition table 22 to the external character creating terminal equipment 4. The external character creating definition table 22 which is transferred from the external character managing terminal equipment 3 is stored in the auxiliary storage unit 13 of the external character creating terminal equipment 4.

The external character creation remote operating section 83 of the external character managing terminal equipment 3 carries out the step S2-6 to make an external character font conversion request with respect to the external character creating terminal equipment 4.

The external character font converter 41 of the external character creating terminal equipment 4 carries out the step S3-1 to convert the external character font. More particularly, the step S3-1 converts the character pattern of the master font data 21 into the format of the external character font 23 according to the external character font creating definition table 22. In other words, based on the logic code of the external character font definition table 22 shown in FIG. 8, the character pattern of the logic code corresponding to the master font data 21 shown in FIG. 5 is first obtained. Then, based on the font code of the external character font definition table 22 shown in FIG. 8, the character pattern is successively stored in the format of the external character font 23 shown in FIG. 6, to thereby complete the conversion of the external character font.

The external character managing terminal processor 51 of the external character creating terminal equipment 4 carries out the step S3-2 to end the external character font conversion. More particularly, the step S3-2 notifies the end of the external character font conversion in the external character font converter 41 to the external character managing terminal equipment 3.

The external character managing terminal equipment 3 carries out the step S2-7 when the end of the external character font conversion is notified from the external character creating terminal equipment 4. The external character font acquiring section 81 of the external character managing terminal equipment 3 carries out the step S2-7 to obtain a predetermined external character font which is converted in the external character creating terminal equipment 4.

The external character font distributing section 91 of the external character managing terminal equipment 3 carries out the step S2-8 to distribute the external character font which is updated by the external character font conversion to each input terminal equipment 2-i. More particularly, the external character font distributing section 91 first notifies the external character font conserving section 142 of each input terminal equipment 2-i which is connected thereto, that the external character font is updated. Then, the external character font conserving section 142 which receives the notification from the external character font distributing section 91 receives the updated external character font which is transferred from the external character font distributing section 91, and replaces the external character font 23 of each input terminal equipment 2-i, to thereby update the external character font.

According to this embodiment, when it is necessary to use a character pattern which is not defined by the internal character, it is possible to build an external character environment without having to carry out a process to extract the external character in advance, by defining the external character code based on the font code table and the external character code table.

In this embodiment, at the stage where the external character code is allocated in the step S2-1, the font code table 62 including the allocated external character code is distributed to each input terminal equipment 2-i. However, it is possible to distribute the font code table 62 including the newly allocated external character code to each input terminal equipment 2-i after the external character is provided from the external character creating terminal equipment 4.

Next, a description will be given of a second embodiment of the present invention which distributes the font code table 62 including the newly allocated external character code to each input terminal equipment 2-i after the external character is provided from the external character creating terminal equipment 4.

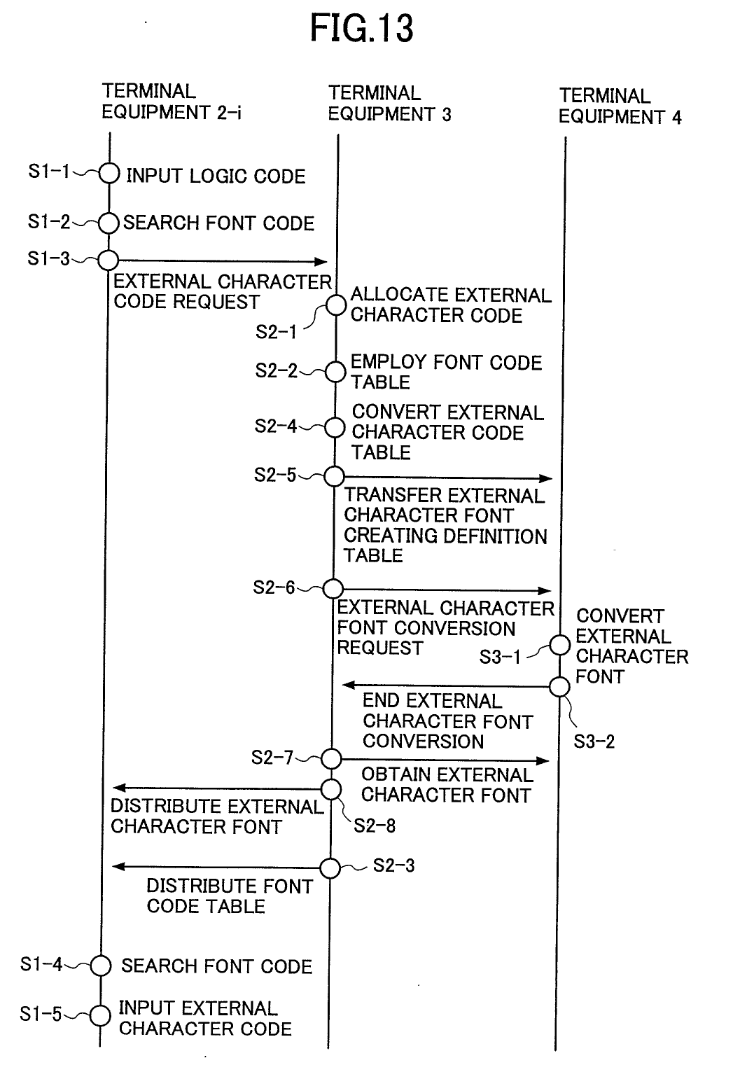

FIG. 13 is a diagram for explaining the operation of the second embodiment of the present invention. In FIG. 13, those steps which are the same as those corresponding steps in FIG. 11 are designated by the same reference numerals, and a description thereof will be omitted. The structure of this embodiment is the same as that of the first embodiment described above, and an illustration and description of the structure of this embodiment will be omitted.

In this embodiment, the external character managing terminal equipment 3 carries out the step S2-3 after the step S2-8. In other words, after distributing the external character font to each input terminal equipment 2-i, the external character managing terminal equipment 3 distributes the font code table 62 which is added with the external character to each input terminal equipment 2-i.

According to this embodiment, it is possible to supply the external character font requested from the input terminal equipment 2-i and the font code table 62′ which includes the font code registered with the external character font approximately at the same time to each input terminal equipment 2-i.

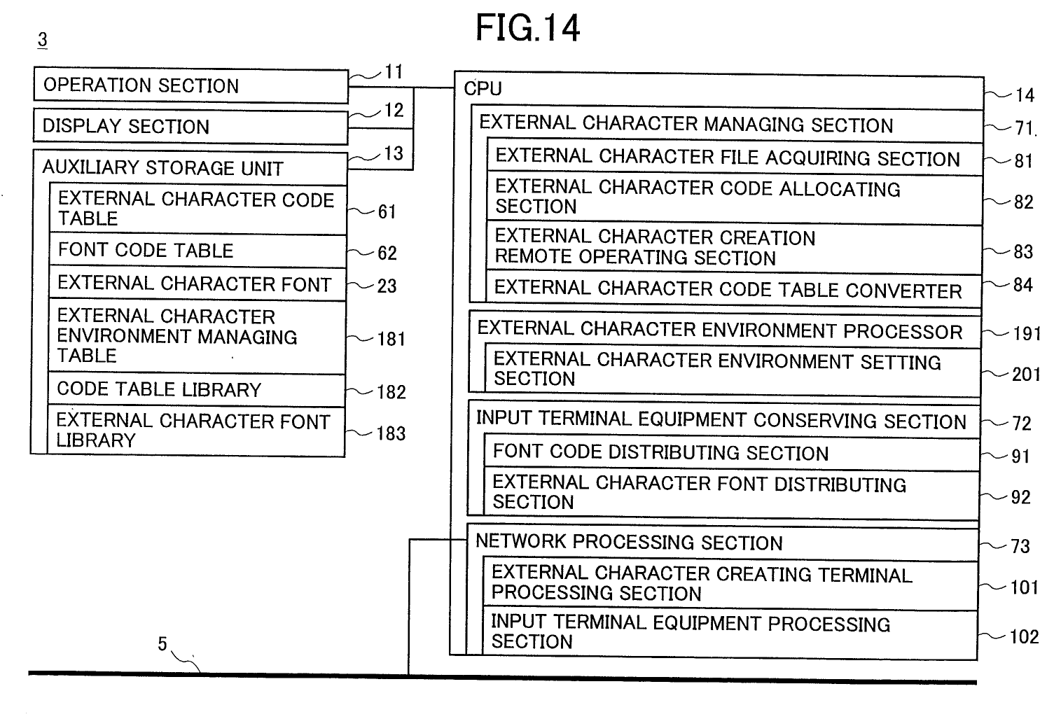

Next, a description will be given of a third embodiment of the present invention. FIG. 14 is a system block diagram showing an external character managing terminal equipment of the third embodiment of the present invention. In FIG. 14, those parts which are the same as those corresponding parts in FIG. 3 are designated by the same reference numerals, and a description thereof will be omitted.

In this embodiment, the auxiliary storage unit 13 of the external character managing terminal equipment 3 includes an external character environment managing table 181, a code table library 182, and an external character font library 183. In addition, the CPU 14 of the external character managing terminal equipment 3 includes an external character environment processor 191.

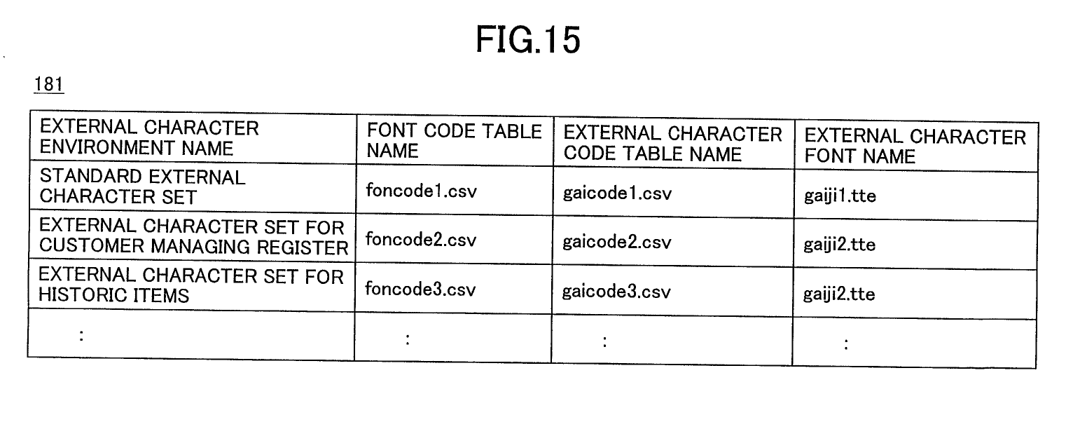

FIG. 15 is a diagram showing a data structure of the external character environment managing table 181 of this embodiment. As shown in FIG. 15, the external character environment managing table 181 includes an external character environment name, a font code table name used in the corresponding external character environment, an external character code table name used in the corresponding external character environment, and an external font name used in the corresponding external character environment. Hence, a font code table, an external character code table and an external character font are selectable from the external character environment managing table 181 depending on the external character environment.

The code table library 182 stores various kinds of font code tables and external character code tables used in the external character environment managing table 181. The external character font library 183 stores various kinds of external character fonts used in the external character environment managing table 181.

The external character environment processor 191 of the CPU 14 is provided with an external character environment setting section 201 for setting the external character environment.

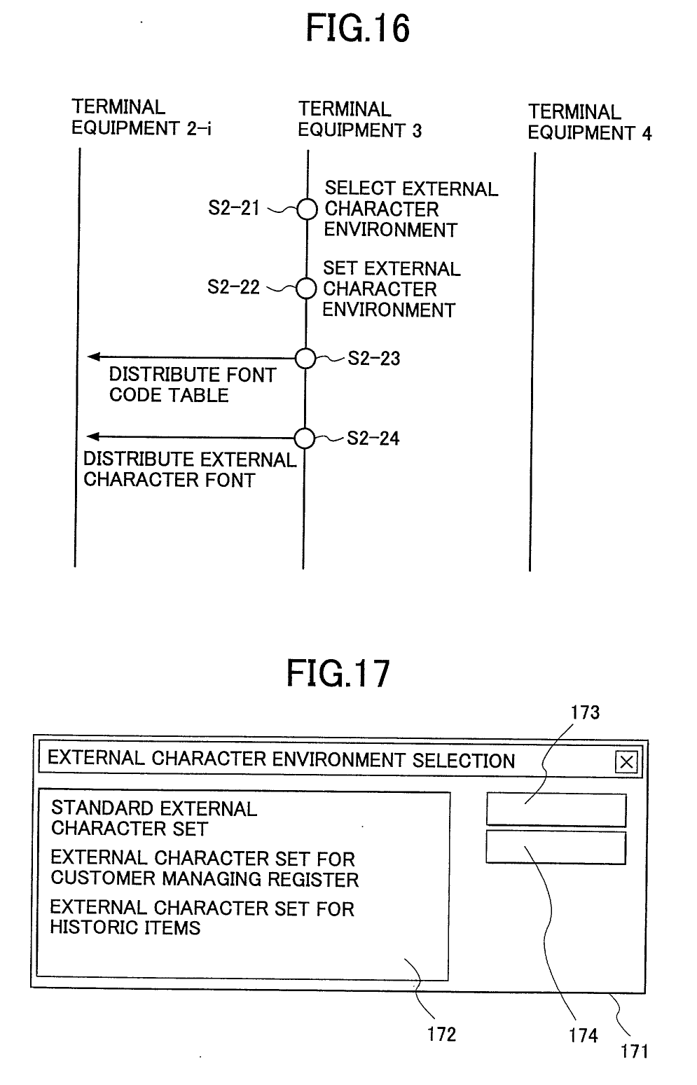

Next, a description will be given of the operation of this embodiment, by referring to FIG. 16. FIG. 16 is a diagram for explaining the operation of this embodiment.

In this embodiment, the external character managing terminal equipment 3 sets the external character environment, so as to specify the external character environment to be used in the input terminal equipment 2-i. Steps S2-21 through S2-24 shown in FIG. 16 are carried out by the external character managing terminal equipment 3.

The step S2-21 selects an external character environment in response to a selection made in an external character environment selection screen 171 which is displayed on the display section 12 by an operation of the operation section 11.

FIG. 17 is a diagram showing the external character environment selection screen 171 of this embodiment. As shown in FIG. 17, the external character environment selection screen 171 includes an external character environment list 172, a select button 173, and a discontinue button 174. The external character environment list 172 indicates a list of external character environments which are selectable. The select button 173 is selected when determining the external character environment which is to be used. The discontinue button 174 is selected when discontinuing the operation of selecting the external character environment.

When the external character environment managing table 181 shown in FIG. 16 is set, the external character environment list 172 is displayed in the external character environment selection screen 171 as shown in FIG. 17. In the external character environment list 172, the external character environments are listed by names such as units of work projects and publications. By selecting a desired external character environment from the external character environment names listed in the external character environment list 172 and selecting the select button 173 by the operation section 11, the desired external character environment is selected.

After the step S2-21, the step S2-22 is carried out by the external character environment setting section 201 shown in FIG. 14 so as to set the external character environment. More particularly, the external character environment setting section 201 obtains the font code table name, the external character code table name and the external character font name from the external character environment managing table 18 shown in FIG. 15, depending on the external character environment name which is selected in the step S2-21.

For example, when “standard external character set” is selected as the external character environment name, the following setting is made. That is, a file “foncodel.csv” is obtained from the font code table name, and the file “foncodel.csv” stored in the code table library 182 is copied to the font code table 62. In addition, a file “gaicodel.csv” is obtained from the external character code table name, and copied to the external character code table 61. Furthermore, a file “gaijil.tte” is obtained from the external character font name, and copied to the external character font 23.

The font code distributing section 91 carries out the step S2-23 to distribute the font code table to each input terminal equipment 2-i.

The external character font distributing section 92 carries out the step S2-24 to distribute the external character font to each input terminal equipment 2-i.

After the external character is set, the external character is managed as described above in conjunction with the first or second embodiment.

An embodiment of a character processing method according to the present invention processes the character in the manner processed by any of the first through third embodiments of the character processing system according to the present invention.

In addition, an embodiment of a computerstorage medium according to the present invention stores a program for causing a computer to process the character as processed in any of the first through third embodiments of the character processing system according to the present invention. The computer-readable storage medium may be formed by any kind of memory or storage unit capable of storing information, such as semiconductor memories, and magnetic, optical and magneto-optical recording media such as disks.

Moreover, an embodiment of a character processing apparatus according to the present invention is formed by at least one of the external character managing terminal equipment 3 and the external character creating terminal equipment 4 described above. In other words, the character processing apparatus according to the present invention is formed by the external character managing terminal equipment 3, but may also include the external character creating terminal equipment 4 in a case where the functions of the external character managing terminal equipment 3 and the external character creating terminal equipment 4 are realized by a single terminal equipment or computer.

Further, the present invention is not limited to these embodiments, but various variations and modifications may be made without departing from the scope of the present invention.

What is claimed is:

1. A character processing apparatus comprising:
a receiving section receiving a request for character information;
a code allocating section allocating a code to the requested character information;
a control section controlling creation of the requested character information; and
a setting section setting created character information with respect to the allocated code.

2. The character processing apparatus as claimed in claim 1 which is connectable to a plurality of input terminal equipments and to a character information creating terminal equipment via a network, wherein:
said receiving section receives the request from one of the input terminal equipments; and
said control section controls creation of the requested character information within the character information creating terminal equipment.

3. The character processing apparatus as claimed in claim 2, further comprising:
a distributing section distributing the created character information to the input terminal equipments.

4. The character processing apparatus as claimed in claim 1, wherein the character information relates to an external character.

5. A character processing system comprising:
at least one input terminal equipment; and
a character processing apparatus coupled to the at least one input terminal equipment,
said input terminal equipment comprising a requesting section requesting character information with respect to the character processing apparatus, said character processing apparatus comprising:
an allocating section allocating a code to the character information requested by the requesting section;
a first notifying section notifying the code to the input terminal equipment;
a creating section creating the requested character information; and
a second notifying section notifying the created character information to the input terminal equipment.

6. The document processing system as claimed in claim 5, wherein said first notifying section notifies the code to the input terminal equipment when the code is allocated by said allocating section.

7. The character processing system as claimed in claim 5, wherein said first notifying section notifies the code to the input terminal equipment after said creating section creates the requested character information.

8. The character processing system as claimed in claim 5, wherein the character information relates to an external character.

9. The character processing system as claimed in claim 5, wherein said second notifying section also notifies the code to the input terminal equipment.

10. A character processing method comprising the steps of:
(a) receiving a request for character information;
(b) allocating a code to the requested character information;
(c) controlling creation of the requested character information; and
(d) setting created character information with respect to the allocated code.

11. The character processing method as claimed in claim 10, wherein the character information relates to an external character.

12. A character processing method comprising the steps of:
(a) requesting character information from an input terminal equipment with respect to a character processing apparatus;
(b) allocating a code to the character information requested by said step (a);
(c) notifying the code to the input terminal equipment;
(d) creating the requested character information; and
(e) notifying the created character information to the input terminal equipment.

13. The character processing method as claimed in claim 12, wherein the character information relates to an external character.

14. A character processing method comprising the steps of:
(a) requesting character information from an input terminal equipment with respect to a character processing apparatus;
(b) allocating a code to the character information requested by said step (a);
(c) creating the requested character information; and
(d) notifying the created character information to the input terminal equipment.

15. The character processing method as claimed in claim 14, wherein the character information relates to an external character.

16. A computer-readable storage medium which stores a program for causing a computer to carry out the steps of:
(a) receiving a request for character information;
(b) allocating a code to the requested character information;
(c) controlling creation of the requested character information; and
(d) setting created character information with respect to the allocated code.

17. The computer-readable storage medium as claimed in claim 16, wherein the character information relates to an external character.

18. A computer-readable storage medium which stores a program for causing a computer to carry out the steps of:
(a) requesting character information from an input terminal equipment with respect to a character processing apparatus;
(b) allocating a code to the character information requested by said step (a);
(c) notifying the code to the input terminal equipment;
(d) creating the requested character information; and
(e) notifying the created character information to the input terminal equipment.

19. The computer-readable storage medium as claimed in claim 18, wherein the character information relates to an external character.

20. A computer-readable storage medium which stores a program for causing a computer to carry out the steps of:
(a) requesting character information from an input terminal equipment with respect to a character processing apparatus;
(b) allocating a code to the character information requested by said step (a);
(c) creating the requested character information; and
(d) notifying the created character information to the input terminal equipment.

21. The computer-readable storage medium as claimed in claim 20, wherein the character information relates to an external character.
